(19) United States
(12) Patent Application Publication
(10) Pub. No.: US 2005/0046511 A1
(43) Pub. Date: Mar. 3, 2005

(54) Switchless combining system and method

(75) Inventor: James Stenberg, Portland, ME (US)

Correspondence Address: BAKER & HOSTETLER LLP;Washington Square, Suite 1100, 1050 Connecticut Avenue, N.W., WASHINGTON, DC, 20036, US

(73) Assignee: SPX CORPORATION

(21) Appl. No.: 10/651,053

(22) Filed: Aug. 29, 2003

(51) Int. Cl. H01P 1/161

(52) U.S. Cl. 333/125; 333/21 A

(57) ABSTRACT

A switchless combiner for high-power broadcast signals incorporates a circular waveguide configured as an orthogonal mode transducer to provide a coherent signal and a phase rotator to steer the combined signal to an output coupler. Out-of-phase RF is absorbed by a station load. The phase rotator is capable of redirecting the output from either of the sources or all of the combined output to the station load. Switching between destinations for the RF components may be made with power applied. The input and output characteristics and mechanical configuration permit the switchless combiner to be integrated with other high-power RF broadcast signal manipulation devices.

### FIELD OF THE INVENTION

The present invention relates generally to high power radio frequency transmission (RF). More particularly, the present invention relates to systems and methods that combine the outputs of multiple high-power radio frequency amplifiers into a single coherent signal for broadcast on a single antenna system.

### BACKGROUND OF THE INVENTION

A basic radio frequency transmitter can use a low-level signal ready for transmission and boost it using successive stages of amplification until the level is high enough (from 25 kilowatts (KW) to 240 KW or more) to be suitable for television broadcasting or another high-power use, such as particle physics research.

Extreme-power amplification often uses vacuum tubes. While tubes are not ideally efficient, they are practical, exhibiting very high amplification ratios, long life, toughness when misused, and low cost per unit power output when compared to current solid-state technologies. Even amplifiers employing vacuum tubes have limited output power, however, and quickly become more costly if they use tubes that are individually capable of greater power output. This situation creates a demand for combiners capable of integrating the signals from multiple moderate-power RF sources with minimal degradation of performance.

Graceful degradation is a consideration that can enter into system design decisions. While every vacuum tube will likely fail eventually, a vacuum tube-based system designed to tolerate failure can have significant added value in environments such as broadcasting. Known hybrid designs that combine the outputs of two vacuum tubes to drive a single output can produce an output level that is effectively the sum of the outputs of the two tubes under normal conditions. In event of failure of one of the tubes, such designs drop not to half power but to one-quarter power—that is, the power of the remaining tube is split between the output, which can be an antenna, and the station load, which dissipates the RF energy in the form of heat and is ordinarily used for testing. Since this failure mode behavior further degrades the working broadcast range of a transmitter system that has already lost half of its power, the alternative of being able to effectively return to half rather than a quarter of output power during a partial failure event can be significant.

Accordingly, there is a need in the art for a passive high-power combiner that can synchronize phase between RF signals from multiple sources, combine those signals into a single signal with low loss, and produce a discrete output that can be applied to other combiners or to a transmission line to feed the high-power signal to a load such as a broadcast antenna.

### SUMMARY OF THE INVENTION

In one aspect, the invention provides a waveguide combiner for high-power radio signals, featuring a first orthogonal mode transducer (OMT) configured to accept RF from two driver circuits; a first polarization rotator, capable of adjusting the phase of each of the two RF signals from the first OMT; and a second OMT configured to couple energy impinging on its input ports into two output conductors.

In another aspect, the invention provides an apparatus for combining high-power RF signals, featuring means for coupling two high-power RF transmission signals into a confining chamber configured to sustain propagation of two signals with orthogonal polarization; means for rotating the phase of both of the coherent signals by an amount equal for each signal to twice the angle between the signal and the rotating means while permitting propagation of the signals to proceed; and means for coupling the high-power UHF transmissions out of the confining chamber.

In yet another aspect, the invention provides a method of combining high-power RF signals into a smaller number of higher-power RF signals, comprising the following steps: coupling coherent, orthogonally spaced RF signals to propagate within a circular waveguide; combining these RF signals by differentially rotating the two signals until they add; placing additional coupling devices at a second position in a dimension-controlled chamber; and coupling the combined signal or any components thereof out of the system using the coupling devices at the second position within the chamber.

There have thus been outlined, rather broadly, the more important features of the invention in order that the detailed description thereof that follows may be better understood, and in order that the present contribution to the art may be better appreciated. There are, of course, additional features of the invention that will be described below and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an oblique view of a switchless combiner configured in accordance with a preferred embodiment of the invention.

FIG. 2 is a side view of the preferred embodiment of a switchless combiner of FIG. 1.

FIG. 3 is a cutaway view of a phase rotator that itself rotates.

FIG. 4A is a sectional view taken through the line A-A in FIG. 2.

FIG. 4B is a sectional view taken through the line B-B in FIG. 2. This figure shows a combiner with the polarizer oriented at zero degrees.

FIG. 5A is a sectional view taken through the line A-A in FIG. 2.

FIG. 5B is a sectional view taken through the line B-B in FIG. 2. This figure shows a combiner with the polarizer oriented at +22.5 degrees.

FIG. 6 is an oblique view of a switchless combiner employing rectangular waveguide sections as input and output feeds to a circular waveguide combiner in accordance with a preferred embodiment of the invention.

FIG. 7 is a partial sectional view showing a choke joint.

FIG. 8 is a partial sectional view showing a spring finger joint.

FIG. 9 is an oblique view of a phase rotator that uses multiple pin sets to rotate the signal phase.

### DETAILED DESCRIPTION OF THE INVENTION

A preferred embodiment of a switchless combiner includes a first orthogonal-mode transducer (OMT), based on the concept of circular waveguide (CW), and functioning as an input device to feed signals from two coherent sources into the combiner. The switchless combiner further includes a circular waveguide polarizer functioning to cause the two source signals to combine or not according to its orientation. The third major element of the switchless combiner is a second circular waveguide OMT functioning as an output device to couple one or both signals to an antenna line or to a second output node.

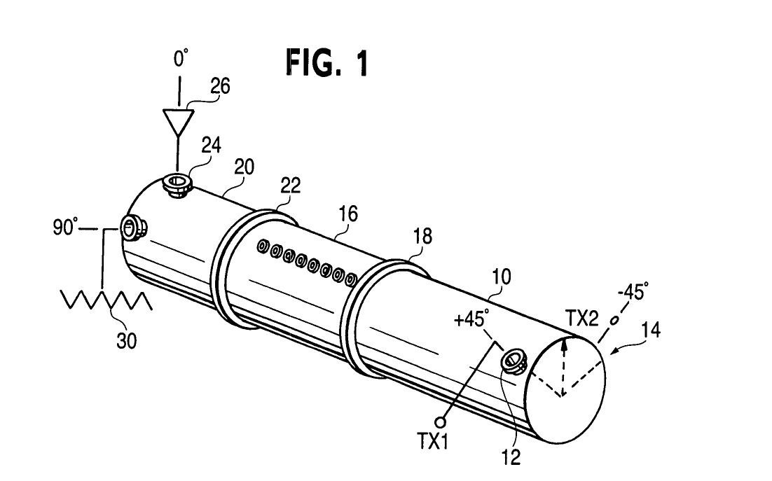

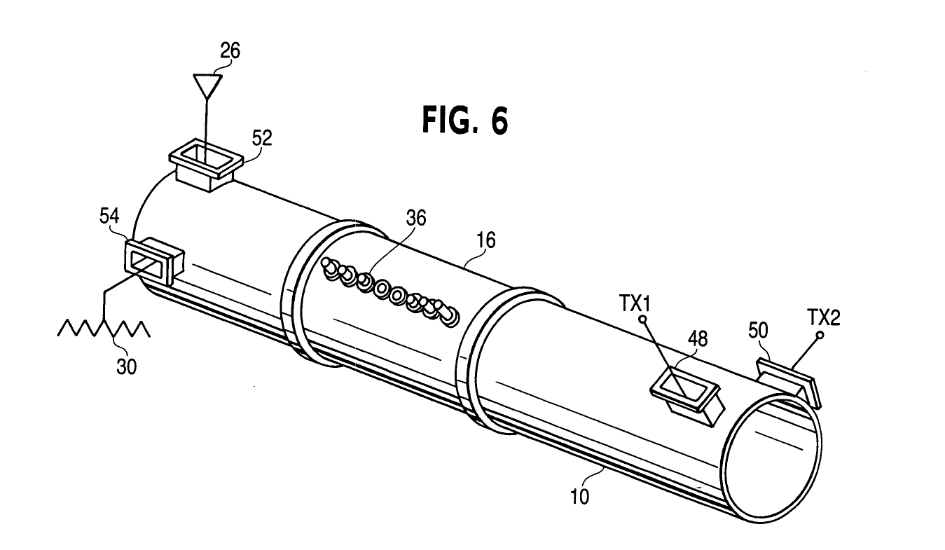

Preferred embodiments of the invention will now be discussed with reference to the above figures, in which like reference numerals refer to like elements throughout. In accordance with a preferred embodiment of the present invention, the switchless combiner uses coaxial lines to feed all signals in and out of the circular waveguide chamber. FIGS. 1, 2, 4, and 5 illustrate this embodiment. In accordance with another embodiment of the present invention, the combiner can use a variety of input and output coupling mechanisms as dictated by the particular needs of an application. For every input and output, a waveguide can be used in place of a coaxial line to couple each signal in or out of the combiner, if the minimum dimensions for propagation and other physical requirements are met. FIG. 6 illustrates a configuration in which waveguides function as the input and output devices.

A preferred embodiment of the apparatus and method is illustrated in FIG. 1. As indicated, circular rather than orthogonal axes are used in the plane of insertion, with the zero angle vertical and positive angles counterclockwise when viewed from the source end. The positive z-axis is the direction of propagation. FIG. 1 shows a first CW OMT 10 fed via a first coaxial fitting 12 with a +45 degree orientation and a second coaxial fitting 14 with a −45 degree orientation. The link between the first CW OMT 10 and a CW polarizer 16 uses a first slip connection 18 to permit free rotation. The polarizer 16 connects to a second CW OMT 20 using a second slip connection 22. The second CW OMT 20 in the preferred embodiment employs as output feeds a third coaxial fitting 24 leading for example to an antenna transmission line (shown schematically by reference number 26) and a fourth coaxial fitting 28 leading for example to a station load (shown schematically by reference number 30).

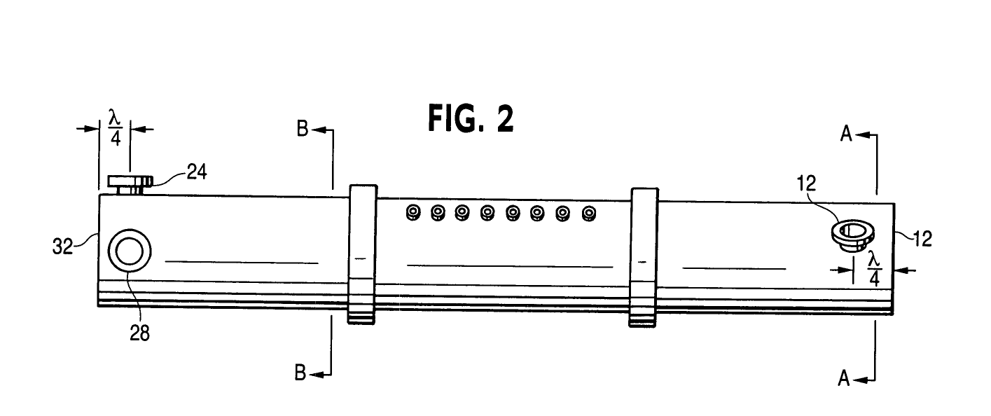

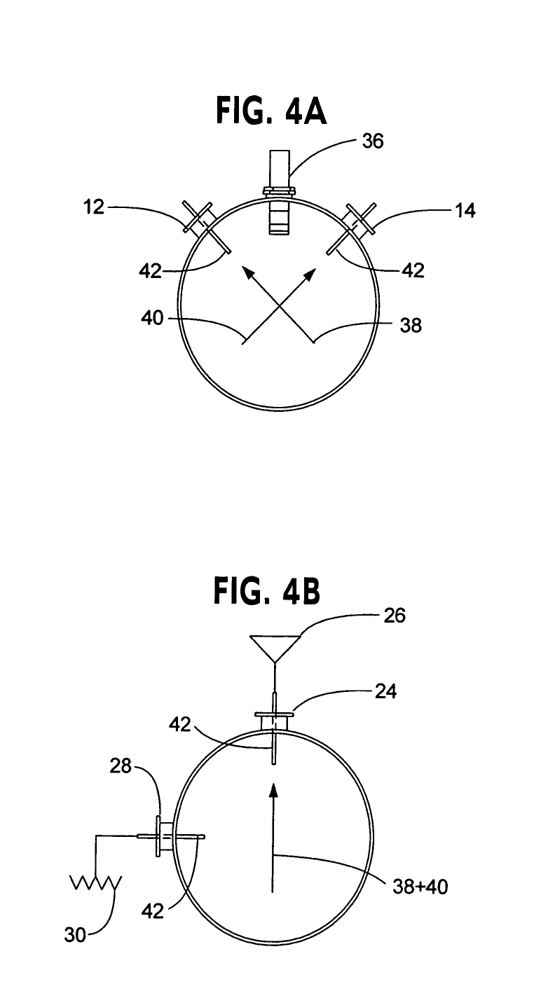

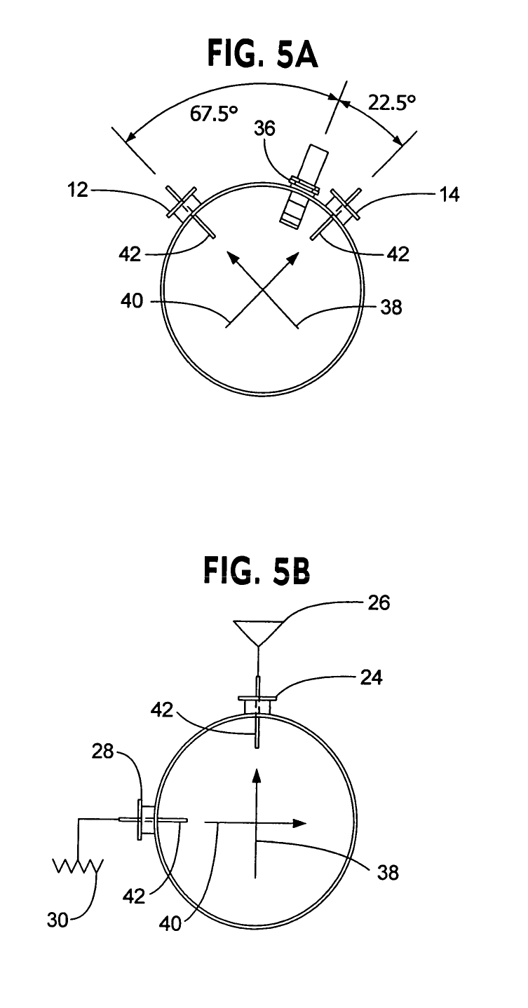

FIG. 2 illustrates the embodiment of FIG. 1 in a side view. Section lines A-A and B-B indicate the views in FIGS. 4A, 4B, 5A, and 5B to be used to illustrate the operation of the combiner in selected modes. The distances from the ends of the OMTs 32 and 34 to the input and output coaxial line feed points 12, 14, 24, and 28 are nominally one-quarter wavelength as shown.

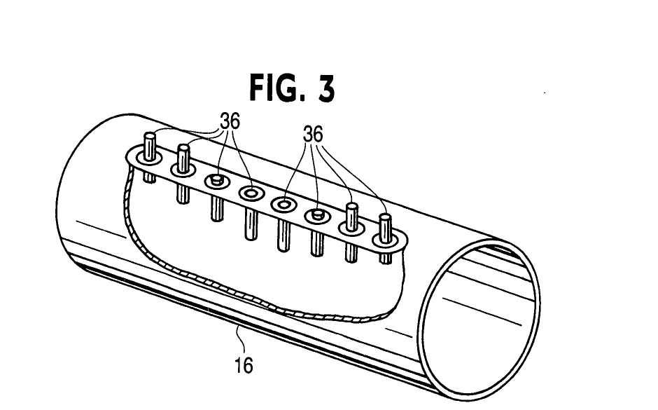

FIG. 3 is a partial cutaway view of a CW phase rotator 16, an element of the preferred embodiment, with the cutaway showing the configuration of the pins 36 that permit it to perform its function. When presented with a single coherent RF signal, the exemplary polarizer can be configured to rotate the phase of the signal twice as far as the angular difference between the pins and the signal, up to 180 degrees.

FIG. 4A shows a first signal 38 oriented at −45 degrees and a second signal 40 oriented at +45 degrees with respect to the pins 36, which are set at 0 degrees. This results, as illustrated in FIG. 4B, in the signals combining, with all of the energy oriented for coupling to the vertical port 24.

In FIG. 5A, a first signal 38 is oriented at −22.5 degrees with respect to the pins 36, and will be rotated, as illustrated in FIG. 5B, to a final orientation of 0 degrees, while a second signal 40 is oriented at +67.5 degrees with respect to the pins 36, and will be rotated, FIG. 5B, to a final orientation of −90 degrees. As shown by comparison between 4A and 4B and between 5A and 5B, respectively, the rotation of the polarity of each signal is twice the angle between the signal and the polarizer.

The design of the polarizer 16 illustrated here is exemplary. Other polarizer designs capable of performing the same function of rotating the waveform components to a greater or lesser extent, while coupling it between the two facing OMTs, may be used. This polarizer design exhibits specific characteristics, such as the property that rotation of the physical body of the polarizer by one degree relative to the fixed input and output OMTs causes two degrees of phase rotation of each of the signals. While intrinsic to the exemplary device, such attributes are not essential to the function of the combiner, nor intrinsic to polarizers in general. Characteristics such as the overall phase shift of the polarizer are determined and controlled by the physical dimensions, layout, and other physical properties of the polarizer.

If one of the sources goes to zero magnitude (the +45 degree vector 38, for example), the combiner positioned as in FIG. 5 allows the remaining signal to be directed to the antenna output 24, while the zero-output transmitter's signal path can be directed to the station load 28. This permits powering down and performing maintenance on the transmitter, thereby decreasing radiated signal strength but not shutting the transmitter off the air. After maintenance, the transmitter can be powered up and will by default transmit into the station load 30, permitting testing. Once the signal from the transmitter has been verified, rotation of the polarizer section 16 of the combiner to the orientation of FIG. 4A will cause the two signals 36 and 38 to be combined at the antenna output 24.

Because the signals 38 and 40 rotate at twice the rate of the physical angle of the polarizer 16 due to the phase shift, all characteristics repeat every 180 degrees. Because each of the signals has two polarities that are effectively interchangeable for broadcast purposes, the signal properties repeat every 90 degrees, and all properties are manifested in any 90-degree arc of polarizer 16 positions.

Coupling between coaxial lines and waveguides is commonly implemented with stub antennas 42 equivalent to tuned lengths of coax center conductor, as shown in FIGS. 4A, 4B, 5A, and 5B. Another coupling method uses conductor loops of the correct size formed in the appropriate plane and bonded to the waveguide wall. RF pickups of both types work for coupling both into and out of the combiner.

For coupling between sections of waveguide operating in different modes, such as the rectangular-to-square transition shown in the alternate embodiment illustrated in FIG. 6, it is preferred that the source and destination waveguides be of suitable size for propagation in the modes required, and correctly oriented. Signals feeding from a first rectangular waveguide 48 and a second rectangular waveguide 50 into the CW combiner 10 on orthogonal axes can propagate and can be coupled out of the combiner into antenna waveguide 52 and station load waveguide 54 in a well-tuned system.

A preferred embodiment of the combiner has joints at the ends of the polarizer that allow it to rotate to select the combiner operating mode. The application of very close dimensional tolerances to the component parts, minimizing gaps, is a preferable way to reduce reflections. Manual alignment and clamping can be employed as part of this process.

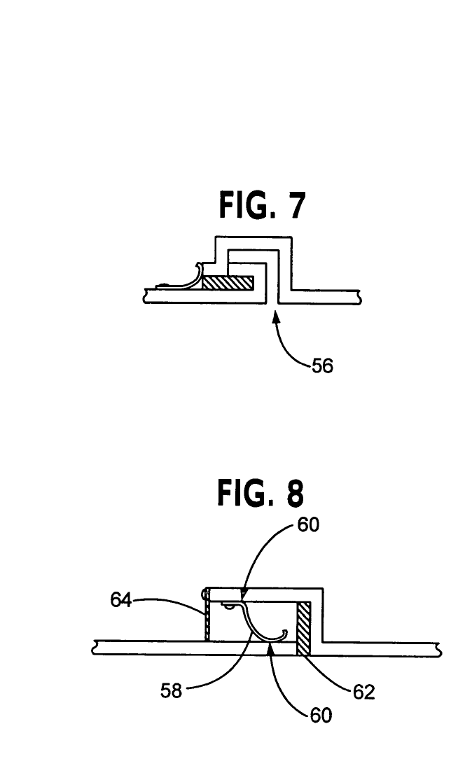

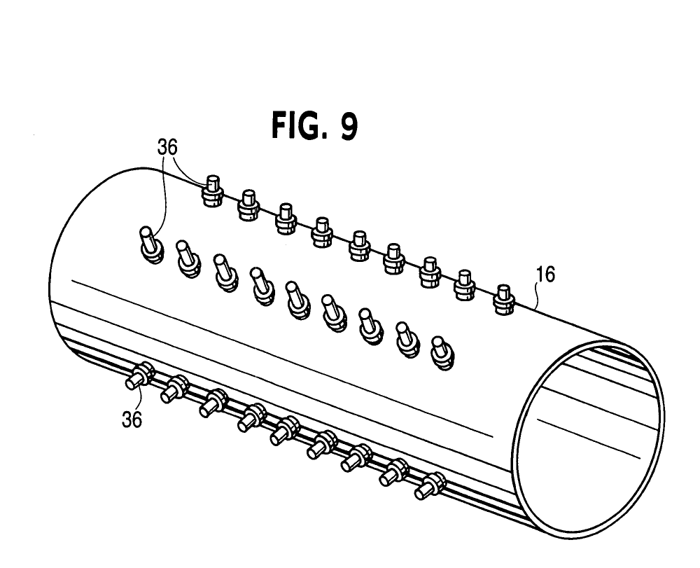

Alternatively, waveguide sections can be joined while permitting motion between sections using choke joints. As shown in FIG. 7, this involves equipping joints with closely dimensioned labyrinth paths 56, so that the RF signals that impinge on the joints reflect repeatedly inside a convoluted chamber and return in phase. Choke joints in some cases are narrow in bandwidth—even a single UHF television channel's bandwidth of 1% or less can be quite large for this type of joint—so that they may be preferable for systems such as X-band radars with short wavelengths and single frequencies or narrow bands.

FIG. 8 shows another waveguide joining approach, commonly referred to as a slip fitting, which uses conductive spring material 58 to provide a direct short circuit 60 between adjacent sections of waveguide with minimal RF reflecting surface. This method can permit some adjustment in length of the sections to improve matching. The methods described herein, as well as others, are preferred, but are presented by way of example only.

A combiner may ordinarily be located close to the active transmitter electronics, rather than for example at the top of a transmission tower, and for this reason can rely on the strict climate control provisions of the transmitter environment to prevent condensation, oxidation, and other corrosive effects from degrading operation. Thus, sealing provisions in a preferred embodiment can be directed to those that promote ease of use rather than protection. For example, the rotation of the polarizer 16 can be facilitated by bearing sleeves 62 and dust shields 64, as shown in section in FIG. 8. Use of a low-friction plastic for such bearings 62 and shields 64 eases rotational and sliding adjustments and can minimize interference with RF joint seals.

An alternative embodiment of the invention can use a rigid structure rather than a rotating polarizer. In such a system, multiple rows of ports may be required into which rows of pins 36 can be inserted to provide alternate phase shifts, thereby effectively changing the rotation angle without turning any parts of the device. In such a rigidly assembled system, the angle of each row of pins is predetermined; the depth of penetration of each pin in each row may be established by analysis and test. Extraction of all rows of pins simultaneously to the withdrawn position provides a default propagation pattern characterized by minimum phase shift, in which configuration some of the RF from each of the inputs is coupled to each of the outputs. Insertion of multiple rows of pins simultaneously produces intermediate phase shifts and effective rotations, again resulting in partial and/or complete coupling between each input and each output, depending on the total phase shift. This nondestructive transition allows switching and combining to be performed with minimal risk of system damage.

Another embodiment of the invention can use a block of dielectric material to alter phase. Materials such as polytetrafluoroethylene (PTFE), sold under such trade names as Teflon®, installed in the form of a block or slab of the proper dimensions within a circular waveguide section, can cause the waveguide section to function as a rotating polarizer.

Automated positioning and position detection, which functions can involve position sensors, position and limit switches, drive motors, instruments to detect levels of output signals, provisions for temporary or permanent insertion of detectors and performance monitors, and remote controls, are optional features to be used with the combiner.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, that fall within the scope of the invention.

1. A radio frequency (RF) passive power combiner, comprising:
a first orthogonal mode transducer (OMT) configured to accept RF from two driver circuits;
a first polarization rotator, capable of adjusting the phase of each of the two RF signals from said first OMT; and
a second OMT configured to couple energy impinging on its input ports into two output conductors.

2. The passive power combiner of claim 1, further comprising:
a first slip connection between said first OMT and said polarization rotator, that provides a low-VSWR rotating connection between said devices; and
a second slip connection between said polarization rotator and said second OMT, that provides a low-VSWR rotating connection between said devices.

3. The passive power combiner of claim 1, further comprising:
a first choke coupling between said first OMT and said polarization rotator, that provides a low-VSWR rotating connection between said devices; and
a second choke coupling between said polarization rotator and said second OMT, that provides a low-VSWR rotating connection between said devices.

4. The passive power combiner of claim 1, further comprising:
a first input coaxial line connection sized to carry the power burden for the feed signal from said first driver circuit to said first OMT; and
a second input coaxial line connection sized to carry the power burden for the feed signal from said second driver circuit to said first OMT.

5. The passive power combiner of claim 1, further comprising:
a first output coaxial line connection sized to carry the power burden for the output signal produced by said combiner from a first port of said second OMT; and
a second output coaxial line connection sized to carry the power burden for the output signal produced by said combiner from a second port of said second OMT.

6. The passive power combiner of claim 1, further comprising:
a first input waveguide connection sized to carry RF at the frequency for the feed signal from said first driver circuit to said first OMT; and
a second input waveguide connection sized to RF at the frequency for the feed signal from said second driver circuit to said first OMT.

7. The passive power combiner of claim 1, further comprising:
a first output waveguide connection sized to carry RF at the frequency for the output signal produced by said combiner from a first port of said second OMT; and
a second output waveguide connection sized to carry RF at the frequency for the output signal produced by said combiner from a second port of said second OMT.

8. The passive power combiner of claim 1, further comprising:
a first input coupler configured to couple the RF signal from said first driver circuit by way of said first input coaxial line into the circular waveguide constituting said first OMT; and
a second input coupler configured to couple the RF signal from said second driver circuit by way of said second input coaxial line into the circular waveguide constituting said first OMT.

9. The passive power combiner of claim 1, further comprising:
a first output coupler configured to couple the RF signal present at said first output port in said second OMT into said first output coaxial line; and
a second output coupler configured to couple the RF signal present at said second output port in said second OMT into said second output coaxial line.

10. The passive power combiner of claim 1, further comprising a pin-type polarization rotator located between the input and output OMTs.

11. The passive power combiner of claim 1, further comprising a dielectric-type polarization rotator located between the input and output OMTs.

12. The passive power combiner of claim 10, wherein said pin-type polarization rotator comprises a single row of pins mounted in a rotatable waveguide section attached to the input and output OMTs by slip connections.

13. The passive power combiner of claim 10, wherein said pin-type polarization rotator comprises a multiplicity of single rows of insertable pins mounted in a fixed waveguide section attached to the input and output OMTs.

14. The passive power combiner of claim 13, wherein insertion of none of said rows of insertable pins in said pin-type polarization rotator establishes a first phase shift and effective rotation angle for each of the signals introduced on the input ports, said phase shift and effective rotation angle determining the proportion of the energy from each input port that is directed to each of the output ports.

15. The passive power combiner of claim 13, wherein insertion of any one of said rows of insertable pins in said pin-type polarization rotator establishes a phase shift and effective rotation angle for each of the signals introduced on the input ports, said phase shift and effective rotation angle determining the proportion of the energy from each input port that is directed to each of the output ports.

16. An apparatus for combining high-power RF transmission signals, comprising:
means for coupling two high-power RF transmission signals into a confining chamber configured to sustain propagation of two signals with orthogonal polarization;
means for rotating the phase of both of said coherent signals by an amount equal for each signal to twice the angle between the signal and the rotating means while permitting propagation of said signals to proceed; and
means for coupling said high-power UHF transmissions out of said confining chamber.

17. The signal combining apparatus of claim 16, wherein said apparatus further comprises means for phase shifting and effectively rotating both of said high-power RF transmission signals to such angles as to allow substantially all of the energy from both of said signals to be coupled out on a first output path.

18. The signal combining apparatus of claim 16, wherein said apparatus further comprises means for phase shifting and effectively rotating both of said high-power RF transmission signals to such angles as to allow substantially all of the energy from both of said signals to be coupled out on a second output path distinct from the first output path.

19. The signal combining apparatus of claim 16, wherein said apparatus further comprises means for phase shifting and effectively rotating both of said high-power RF transmission signals to such angles as to allow substantially all of the energy from each of said signals to be coupled out on an output path distinct from that on which the energy of the other signal is coupled.

20. A method of combining RF signals, comprising the following steps:
coupling coherent, orthogonally spaced RF signals to propagate within a circular waveguide;
combining these RF signals by differentially rotating the two signals until they add;
placing additional coupling devices at a second position in a dimension-controlled chamber; and
coupling the combined signal or any components thereof out of the system using the coupling devices at the second position within the chamber.

21. The RF signal combining method of claim 20, further comprising the step of phase shifting and effectively rotating both of the RF transmission signals to such angles as to allow substantially all of the energy from both of the signals to be coupled out on a first output path.

22. The RF signal combining method of claim 20, further comprising the step of phase shifting and effectively rotating both of the RF transmission signals to such angles as to allow substantially all of the energy from both of the signals to be coupled out on a second output path distinct from the first output path.

23. The RF signal combining method of claim 20, further comprising the step of phase shifting and effectively rotating both of the RF transmission signals to such angles as to allow substantially all of the energy from each of the signals to be coupled out on an output path distinct from that on which the energy of the other signal is coupled.
